(19) United States
(12) Patent Application Publication
(10) Pub. No.: US 2003/0198000 A1
(43) Pub. Date: Oct. 23, 2003

(54) Device for detecting errors in the leakage current path of a high voltage surge diverter

(76) Inventors: Volker Hinrichsen, Darmstadt (DE); Kai Steinfeld, Berlin (DE)

Correspondence Address: MORRISON & FOERSTER LLP, 1650 TYSONS BOULEVARD, SUITE 300, MCLEAN, VA, 22102, US

(21) Appl. No.: 10/311,867

(22) PCT Filed: Apr. 10, 2001
(86) PCT No.: PCT/DE01/01493

(30) Foreign Application Priority Data
Jun. 23, 2000 (DE) 100 30 669.1

(51) Int. Cl. H01H 47/00

(52) U.S. Cl. 361/139

(57) ABSTRACT

A device which triggers off a drive mechanism (6) when an error occurs is provided in order to detect an error in a high voltage surge diverter. The drive mechanism (6) is triggered by an electrical signal. The electrical signal is produced according to the current which flows in the leakage path of the high voltage surge diverter. The inventive device can be, for instance, embodied as a high voltage surge diverter disconnecting device or as a failure signal device for high voltage surge diverters.

### CLAIM FOR PRIORITY

This application claims priority to International Application No. PCT/DE01/01493 which was published in the German language on Dec. 27, 2001.

### TECHNICAL FIELD OF THE INVENTION

The invention relates to an apparatus for detection of a fault in the dissipation current path of a high-voltage surge arrester having a drive which produces drive forces by means of an expanding gas and can be initiated when a fault occurs.

### BACKGROUND OF THE INVENTION

An apparatus for detecting a fault is known, for example, from PCT application WO 97/10631. The apparatus is used in order to interrupt a dissipation current of a faulty high-voltage surge arrester. The high-voltage surge arrester has varistor 9variable resistor) elements. The apparatus has a dissipation current path, an electrode arrangement arranged electrically in parallel with it, and a drive. An explosive charge which can be triggered thermally is used as the drive.

Owing to the design configuration of the electrode arrangement and of the dissipation current path of the apparatus, a correspondingly large dissipation current commutates onto the electrode arrangement both during a regular dissipation process and in the event of a fault in the dissipation current path of the high-voltage surge arrester, forming an arc.

The thermal energy which is produced in this process within the apparatus is intended to trigger the drive only when a fault is present in the high-voltage surge arrester. Triggering is essentially dependent on the magnitude and the time duration of the dissipation current that flows. The major triggering criteria, such as the triggering current and the triggering delay, are virtually impossible to set in a defined manner. This can lead to undesirable spurious triggering of the drive during regular dissipation processes.

### SUMMARY OF THE INVENTION

The present invention disclose designing an apparatus for detection of a fault in the dissipation current path of a high-voltage surge arrester having an improved response, in order to avoid spurious triggering.

In one embodiment according to the invention, the drive is controlled by an electrical signal which is produced as a function of a current flowing in the dissipation current path.

The production of the triggering signal as a function of the current flowing in the dissipation current path allows reliable triggering of the drive. The dependent production makes it possible to distinguish very accurately between a dissipation current and a fault current. The electrical signal can be detected and processed well.

Furthermore, it is preferable to provide for the dissipation current path to form the primary winding of an inductive transformer, whose secondary winding emits the electrical signal.

The dissipation current path can be surrounded well by the transformer, thus allowing a compact physical shape. An annular configuration of the transformer is particularly advantageous. The use of the dissipation current path as the primary winding is a physically simple solution.

A further advantageous refinement provides for the transformer to have a ferromagnetic core.

The ferromagnetic core bundles the lines of force of the magnetic field and improves the transmission response of the transformer. An annular configuration of the ferromagnetic core has been found to be particularly advantageous. The ferromagnetic core may be mechanically fitted with the secondary winding. The magnetic characteristic variables of the ferromagnetic core, such as the permeability and saturation induction, assist more accurate adjustment of the triggering criteria.

It is furthermore preferable to provide for the drive to be preceded by an electronic filter through which the signal has to pass.

The use of an electronic filter makes it possible to specifically configure the response of the apparatus. It is thus possible to distinguish in a very highly reliable manner between a fault current and a regular dissipation current. The filter characteristics of a filter such as this can easily be matched to the respective operating conditions.

It is also possible to provide for the electronic filter to be a frequency-selective filter.

One advantageous variable for distinguishing between fault currents and regular dissipation currents is their frequency. Typically, the regular dissipation currents are at a frequency which is considerably greater than the typical power supply system frequency of, for example, 50 or 60 Hz. If a fault now occurs in the high-voltage surge arrester, then the power supply system frequency of 50 or 60 Hz is superimposed on the fault current that occurs. A multistage electronic filter has been found to be particularly effective for selection of the power supply system frequency. Low-pass filter circuits, which are known per se, are typically used for a filter such as this. In principle, a filter such as this can also be used for DC voltages.

It is furthermore preferable to provide for the drive to control a high-voltage surge arrester isolating apparatus.

When the apparatus is used in high-voltage surge arrester isolating apparatuses, a considerable improvement in the reliability of these apparatuses can be achieved at little cost. Apparatuses such as these can be retrofitted without any problems.

It is also possible to provide for the drive to control a failure signaling apparatus for high-voltage surge arresters.

The use of an apparatus such as this allows failure signaling apparatuses to be produced which are very complex and are highly reliable.

### BRIEF DESCRIPTION OF THE DRAWINGS

The invention will be described in more detail in the following text, and is illustrated with reference to the drawings, in which:

FIG. 1 shows an apparatus for detection of a fault in the dissipation current path of a high-voltage surge arrester in an exemplary embodiment as a high-voltage surge arrester isolating apparatus.

FIG. 2 shows an apparatus for detection of a fault in the dissipation current path of a high-voltage surge arrester in an exemplary embodiment as a failure signaling apparatus.

FIG. 3 shows a failure signaling apparatus having a triggering drive.

FIG. 4 shows a triggered failure signaling apparatus.

FIG. 5 shows a circuit arrangement for a frequency-selective filter.

### DETAILED DESCRIPTION OF THE INVENTION

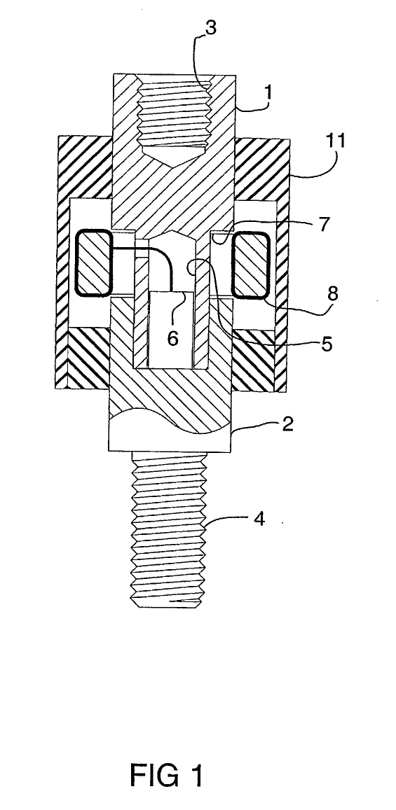

Functionally identical components are provided with the same reference symbols in all the figures. FIG. 1 shows an apparatus for detection of a fault in the dissipation current path of a high-voltage surge arrester, which is in the form of a high-voltage surge arrester isolating apparatus. The apparatus has a first electrically conductive body 1 and a second electrical body 2. The first electrically conductive body 1 has a first threaded hole 3 for making contact between the apparatus and a high-voltage surge arrester. The second electrically conductive body 2 furthermore has a threaded bolt 4 in order to allow the apparatus to make contact with a ground potential. The first and the second electrically conductive bodies 1, 2 are electrically conductively connected to one another. The electrical direct-current resistance between the threaded hole 3 and the threaded bolt 4 is relatively low, for example less than 10 m Ω. The first and the second electrically conductive bodies 1, 2 form a part of the dissipation current path of the high-voltage surge arrester. The first electrically conductive body 1 has a blind hole 5 for accommodating a gas generator which acts as the drive 6 and which can be triggered electrically. Gas generators such as these are known, for example, from the inflatable airbags which are used in vehicle construction. The second electrically conductive body 2 is connected to the first electrically conductive body 1 such that the blind hole 5 for accommodating the gas generator is sealed. A ferromagnetic annular core 7 is arranged around the first electrically conductive body 1. This ferromagnetic annular core 7 is fitted with a secondary winding 8. This secondary winding 8 is connected to a triggering unit for the gas generator. The primary winding is formed by the first and the second electrically conductive bodies 1, 2. The apparatus is surrounded by a housing 11.

The very small leakage currents which occur on a high-voltage surge arrester having varistor elements can flow away to ground potential via the first and second electrically conductive bodies 1, 2. During a dissipation process in the high-voltage surge arrester, the dissipation current which occurs during this process is likewise dissipated to ground potential via the first and second electrically conductive bodies 1, 2. The magnetic characteristics of the ferromagnetic annular core, such as saturation induction, permeability and frequency response of the ferromagnetic annular core 7, are dimensioned such that the voltage which is produced in the secondary winding 8 by the dissipation current which flows for a short time (for example for a few milliseconds) is not sufficient to trigger the gas generator. When a fault occurs, for example a flashover in a varistor element, a longer-lasting fault current (for example >100 ms) flows through the first and second electrically conductive bodies 1, 2, so that the duration of the voltage which is produced by the fault current in the secondary winding 8 is sufficient to trigger the gas generator. This results in the interior of the blind hole 5 in the first electrically conductive body 1, which is sealed by the second electrically conductive body 2, in such a pressure rise that the second electrically conductive body 2 is disconnected from the first electrically conductive body 1. Appropriate configuration of the ferromagnetic annular core 7 and of the secondary winding 8 ensures highly selective triggering of the gas generator. The selective triggering is also assisted by the different time responses of the dissipation current and of the fault currents.

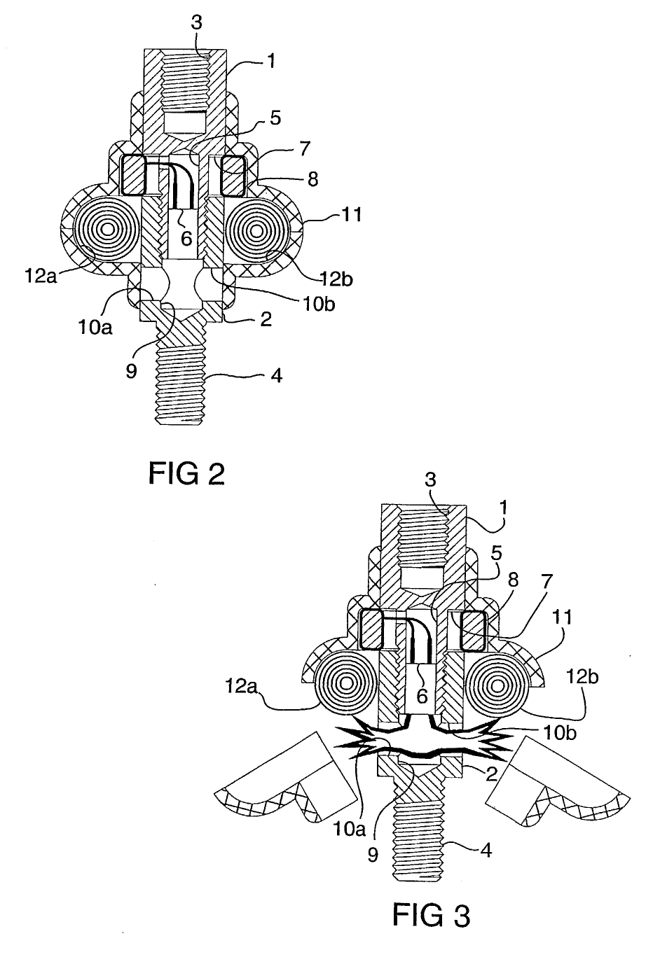

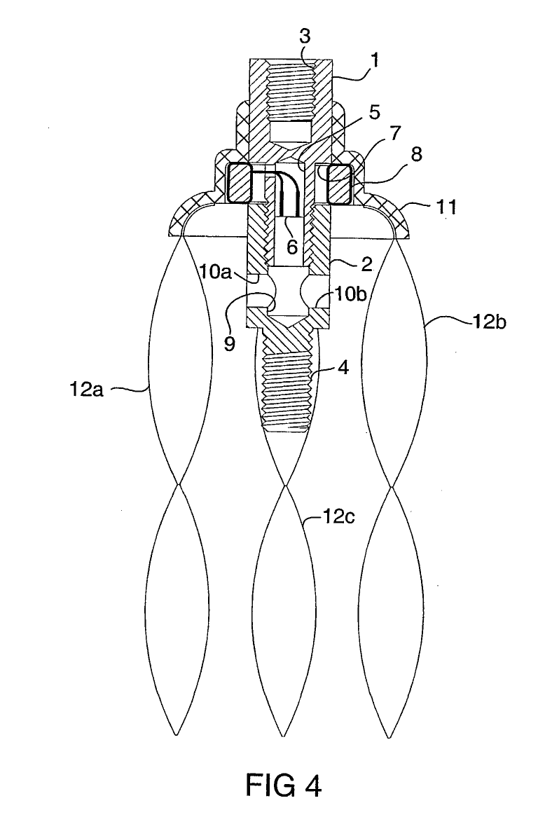

FIGS. 2, 3 and 4 show the configuration of the apparatus for detection of a fault in the dissipation current path of a high-voltage surge arrester as a failure signaling apparatus. The apparatus once again has a first electrically conductive body 1 and a second electrically conductive body 2. The first electrically conductive body 1 has a threaded hole 3 for connection of the apparatus to a high-voltage surge arrester. The second electrically conductive body 2 has a threaded bolt 4 for connection of the apparatus to a ground potential. The first and the second electrically conductive bodies 1, 2 are electrically conductively connected to one another. The electrical direct-current resistance between the threaded hole 3 and the threaded bolt 4 is relatively low, for example less than 10 m Ω. The first electrically conductive body 1 has a blind hole 5 for accommodating a gas generator which acts as the drive 6 and can be initiated electrically. The second electrically conductive body 2 likewise has a blind hole 9, which develops the blind hole 5 in the first electrically conductive body 1. In addition, openings 10a, 10b are provided, which radially widen the blind hole 9 in the second electrically conductive body 2 in the outward direction. A ferromagnetic annular core 7 to which a secondary winding 8 is fitted is arranged around the first electrically conductive body 1. The first and the second electrically conductive bodies 1, 2 act as a primary winding. The secondary winding 8 is electrically locked out to a triggering unit for the gas generator. The apparatus is surrounded by a multipart housing 11. Signal flags 12a, 12b, 12c are arranged within the housing 11. The multipart housing 11 covers the openings 10a, 10b of the blind hole 9 in the second electrically conductive body 2.

The gas generator is triggered in the same way as described in the example in FIG. 1. When a fault occurs in the dissipation current path of a high-voltage surge arrester, a current flows through the first and second electrically conductive bodies 1, 2 such that a voltage is induced in the secondary winding 8, whose duration is sufficient to trigger the gas generator. The gas generator produces an increased gas pressure in the sealed area surrounding it, which gas pressure is sufficiently high that parts of the multipart housing 11 are broken off, and the gas is dissipated via the openings 10a, 10b. The signal strips 12a, 12b, 12c which are arranged within the housing 11 are released, and are unfolded. The faulty high-voltage surge arrester can thus easily be identified. The dissipation current path of the high-voltage surge arrester is not interrupted.

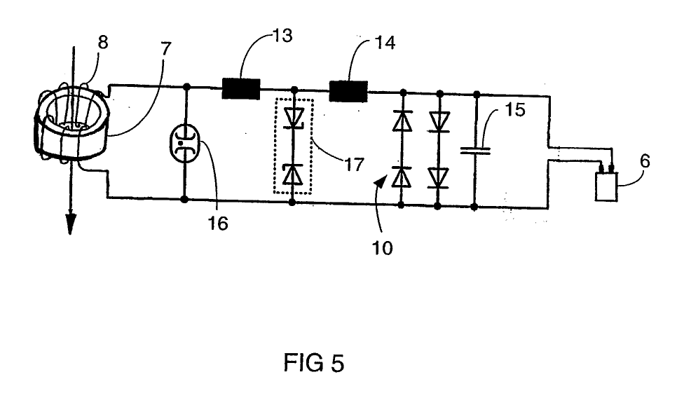

The triggering of the drive 6 can be controlled even more precisely by evaluating the time profiles of the dissipation currents and of the fault currents. The frequency-selective filter which is illustrated in FIG. 5 is used for this purpose. The frequency-selective filter is connected in the transmission path of the electrical signal between the secondary winding 8 and the gas generator, which acts as the drive 6 and can be triggered electrically. The filter has a first coupling coil 13 and a second coupling coil 14, which are electrically connected in series with one another. A capacitor 15 is connected in parallel with the gas generator. A number of parallel current paths with protection elements are provided as protection circuitry. A protection spark gap 16, protection circuitry by means of zener diodes 17 and an arrangement of protection diodes 18 connected back-to-back in parallel are provided as protection elements. The frequency-selective filter is designed as a lowpass filter, such that a signal at a low frequency is passed through to the gas generator, where it results in triggering of the gas generator. The filter prevents the gas generator from being triggered when a high-frequency signal occurs.

1. An apparatus for detection of a fault in the dissipation current path of a high-voltage surge arrester, having a drive (6) which produces drive forces by means of an expanding gas and can be initiated when a fault occurs,
characterized
in that the drive (6) is controlled by an electrical signal which is produced as a function of a current flowing in the dissipation current path.

2. The apparatus as claimed in claim 1,
characterized
in that the dissipation current path forms the primary winding of an inductive transformer, whose secondary winding (8) emits the electrical signal.

3. The apparatus as claimed in claim 2,
characterized
in that the transformer has a ferromagnetic core (7).

4. The apparatus as claimed in one of claims 1 to 3,
characterized
in that the drive (6) is preceded by an electronic filter through which the signal has to pass.

5. The apparatus as claimed in claim 4,
characterized
in that the electronic filter is a frequency-selective filter.

6. The apparatus as claimed in one of claims 1 to 5,
characterized
in that the drive (6) controls a high-voltage surge arrester isolating apparatus.

7. The apparatus as claimed in claims 1 to 5,
characterized
in that the drive (6) controls a failure signaling apparatus for high-voltage surge arresters.
